(19) United States
(12) Patent Application Publication
(10) Pub. No.: US 2025/0194581 A1
(43) Pub. Date: Jun. 19, 2025

(54) Wild Animal Deterrent Apparatus

(71) Applicant: Jacob Kohn, Cape Coral, FL (US)

(72) Inventor: Jacob Kohn, Cape Coral, FL (US)

(21) Appl. No.: 18/982,017

(22) Filed: Dec. 16, 2024

Related U.S. Application Data
(60) Provisional application No. 63/610,081, filed on Dec. 14, 2023.

(51) Int. Cl. A01M 29/06; A01M 29/16

(52) U.S. Cl. CPC A01M 29/06; A01M 29/16

(57) ABSTRACT

A wild animal deterrent apparatus includes a backpack that accommodates a collapsed display component bearing a deterrent graphic image. The backpack includes at least one compressed air or gas cartridge communicably connected to an inflatable bladder on the graphic display component. A valve interconnecting the cartridge and the bladder is selectively opened, which inflates the bladder.

### FIELD OF THE INVENTION

This invention relates to a wild animal deterrent apparatus and, in particular, to an apparatus that is deployed quickly, easily and effectively to deter potential attacks by aggressive and/or dangerous wild animals.

### BACKGROUND OF THE INVENTION

Outdoor activities such as hiking, backpacking, camping and hunting often occur in forests, wilderness and other remote areas occupied by bears or other potentially dangerous wild animals. If a person encounters such a wild animal and the animal is startled or feels threatened, it may become aggressive and even attack the person. This risks the human being severely injured or even killed, particularly where the bear or other wild animal is larger than the person. Often the person's only way to counter a wild animal attack is to employ a firearm or other lethal weapon to kill or seriously injure the animal. Currently there are no known devices available for effectively reducing the risk and consequences to humans of such attacks, as well as the potential harm to the animal encountered.

### SUMMARY OF THE INVENTION

It is therefore an object of the present invention to provide an apparatus for quickly, easily and effectively deterring an attack by a wild animal on a person that encounters the animal in a forest, wilderness or other remote outdoor setting.

It is a further object of this invention to provide a wild animal deterrent apparatus that reduces the risk of a person being killed or seriously injured from an attack by a wild animal the person encounters.

It is a further object of this invention to provide a wild animal deterrent apparatus that employs both visual and audible components to frighten an aggressive wild animal before it attacks and potentially injures a person encountering the animal.

It is a further object of this invention to provide a wild animal deterrent apparatus that effectively frightens a large wild animal to deter a potential attack by the animal and reduce the possibility of the animal being harmed or killed by a person defending against such an attack.

It is a further object of this invention to provide a wild animal deterrent apparatus mounted conveniently in a backpack that may be carried comfortably and operated quickly, easily and effectively by persons engaged in various outdoor activities including, but not limited to hiking, backpacking, camping and hunting.

It is a further object of this invention to provide a wildlife animal deterrent apparatus that allows a person encountering a potentially aggressive and/or dangerous wild animal to frighten the animal away without having to employ a lethal weapon or otherwise harm the animal.

This invention features a wild animal deterrent apparatus including a container that accommodates a collapsed display component carrying a graphic image of a large, aggressive animal. An inflatable bladder having a passageway is formed through the display component. A source of compressed air or other gas is disposed within the container and communicably connected to the bladder in the display component. A valve is also disposed within the container and operably interconnected between the source of compressed gas and the bladder in the display component. A valve actuator is operably connected to the valve. The valve actuator is pulled or otherwise operated to selectively open the valve, which transmits air or other gas from the compressed gas source to the passageway of the bladder. This inflates the bladder, which causes the collapsed display component to open and extend outwardly from the container through an opening of the container to reveal the graphic wild animal image carried by the display component.

In a preferred embodiment, the container includes a backpack or wearing apparel, such as a jacket, coat or vest, having an interior compartment. The interior compartment may accommodate one or more compressed air or CO2 cartridges that comprise the compressed gas source. One or more gas transmission tubes may be communicably interconnected between the valve and the display component's bladder. A gas distribution chamber mounted within the compartment of the backpack or apparel may communicably interconnect the one or more gas transmission tubes to the bladder of the display component.

The inflatable bladder may include a peripheral bladder portion that extends peripherally about the display component. The peripheral bladder portion may include a lower bladder segment extending along a lower edge of the display component and an upper bladder segment that extends between the respective ends of the lower bladder segment. The bladder may also include a plurality of radially diverging bladder segments, each of which communicably interconnects the lower bladder segment to a respective location on the upper bladder segment. The distribution chamber communicably interconnects the gas transmission tubes to the lower and upper bladder segments and to the radially diverging bladder segments interconnecting the lower and upper bladder segments.

An audible air horn or other compressed gas activated siren may be mounted within the backpack or other container. Preferably, the horn is operably connected to the valve such that when the valve is closed the horn remains silent. After the valve has been opened to transmit compressed gas to the bladder of the display component, the actuator may be pulled further or otherwise operated to deliver compressed air through the valve to the air horn. This, in turn, activates and sounds the air horn or siren.

Preferably, the display component incudes a display panel having opposing front and rear sides. The interior passageway of the inflatable bladder may be formed between front and rear sides of the display panel. The aggressive animal image may be formed on at least the front face or side of the display panel. The image should be larger and preferably significantly larger than the size of any wild animal that would be encountered in the area. For example, if the most pertinent wild animals in the area are bears, the display panel should depict an image that is significantly larger in width and height than the actual width and height of any bear in the vicinity wherein the apparatus is being used.

### BRIEF DESCRIPTION OF THE DRAWINGS

Other objects, features and advantages will occur from the following description of a preferred embodiment and the accompanying drawings, in which:

FIG. 1 is a front elevational view of a preferred wild animal deterrent apparatus according to this invention with the display component in an open and deployed condition to frighten a wild animal that has been encountered by a person activating the device;

FIG. 2 is a simplified cross sectional and partially cut-away view of the wild animal deterrent apparatus illustrating the components of the device mounted within the backpack and showing the display component in a collapsed condition (in phantom) and alternatively in an open and deployed condition;

FIG. 3 is a perspective view of a hiker encountering a bear prior to activating of the wild animal deterrent device;

FIG. 4 is a perspective view showing how the display component of the deterrent device is activated, opened and deployed for scaring and deterring a bear or other wild animal;

FIG. 5 is a perspective view of a preferred valve closure having a locking notch;

FIG. 6 is an elevational fragmentary and simplified view depicting the lockable valve closure and a corresponding disengaged locking pin with the closure in a closed state blocking the flow of compressed gas through the valve;

FIG. 7 is a view similar to FIG. 6 with the valve closure in an open state permitting the flow of compressed gas through the valve and depicting the locking pin engaged with the lockable valve closure to hold the valve closure in an open state;

FIG. 8 is a perspective view of an alternative valve closure that does not include a locking notch; and

FIG. 9 is a schematic view of an alternative embodiment wherein the valve includes a pair of valve closures and corresponding compressed air sources and air transmission channels through the valve for respectively inflating the bladder and operating the an air horn.

### DETAILED DESCRIPTION OF PREFERRED EMBODIMENTS

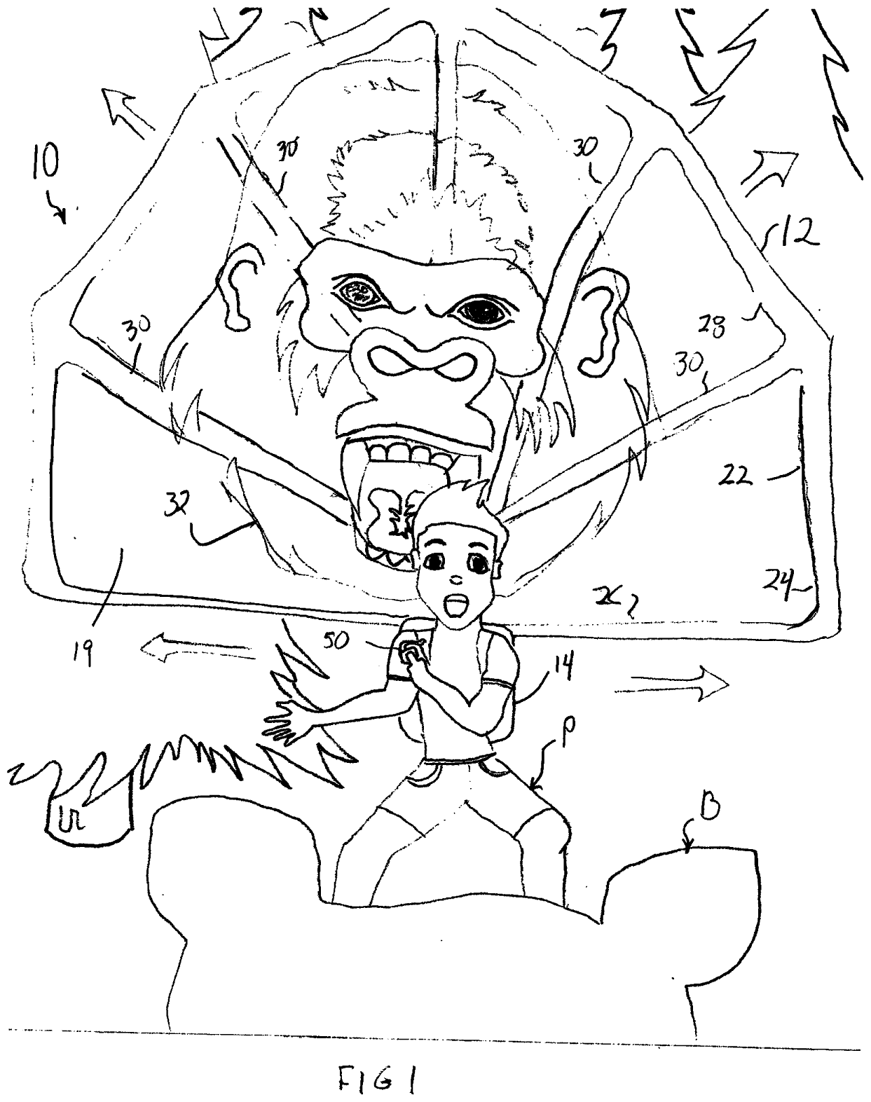

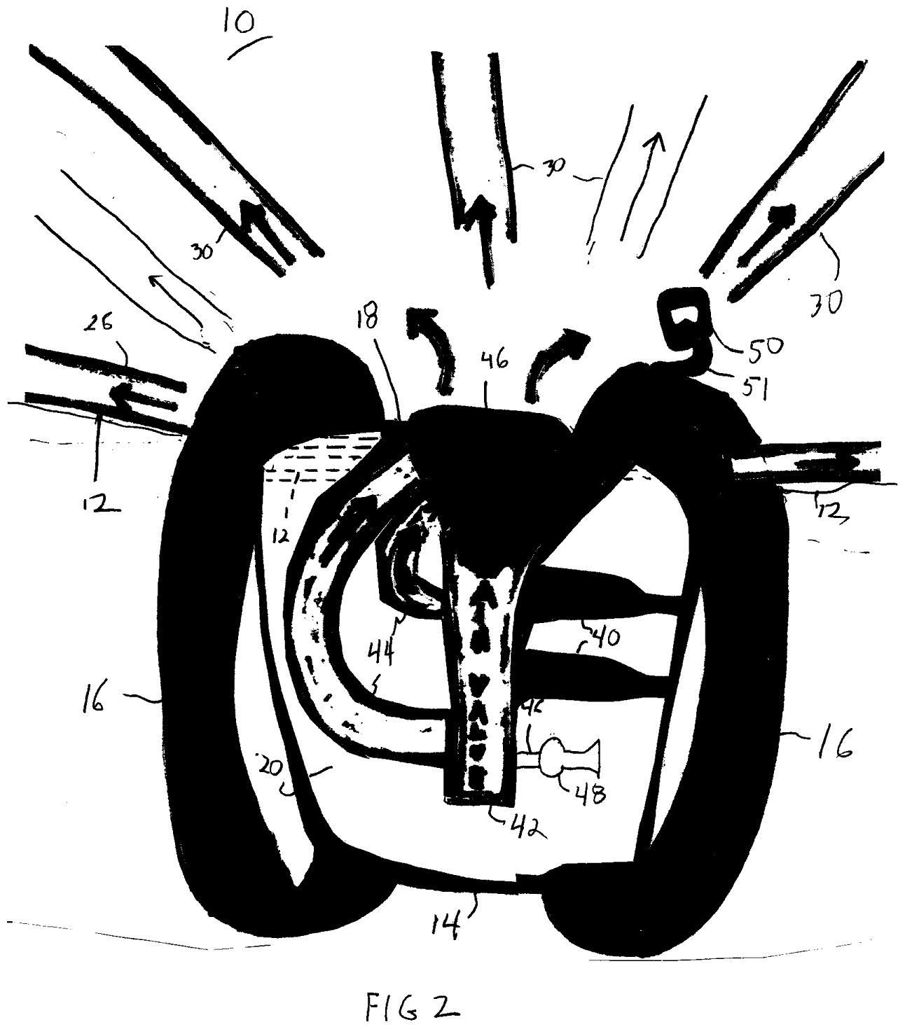

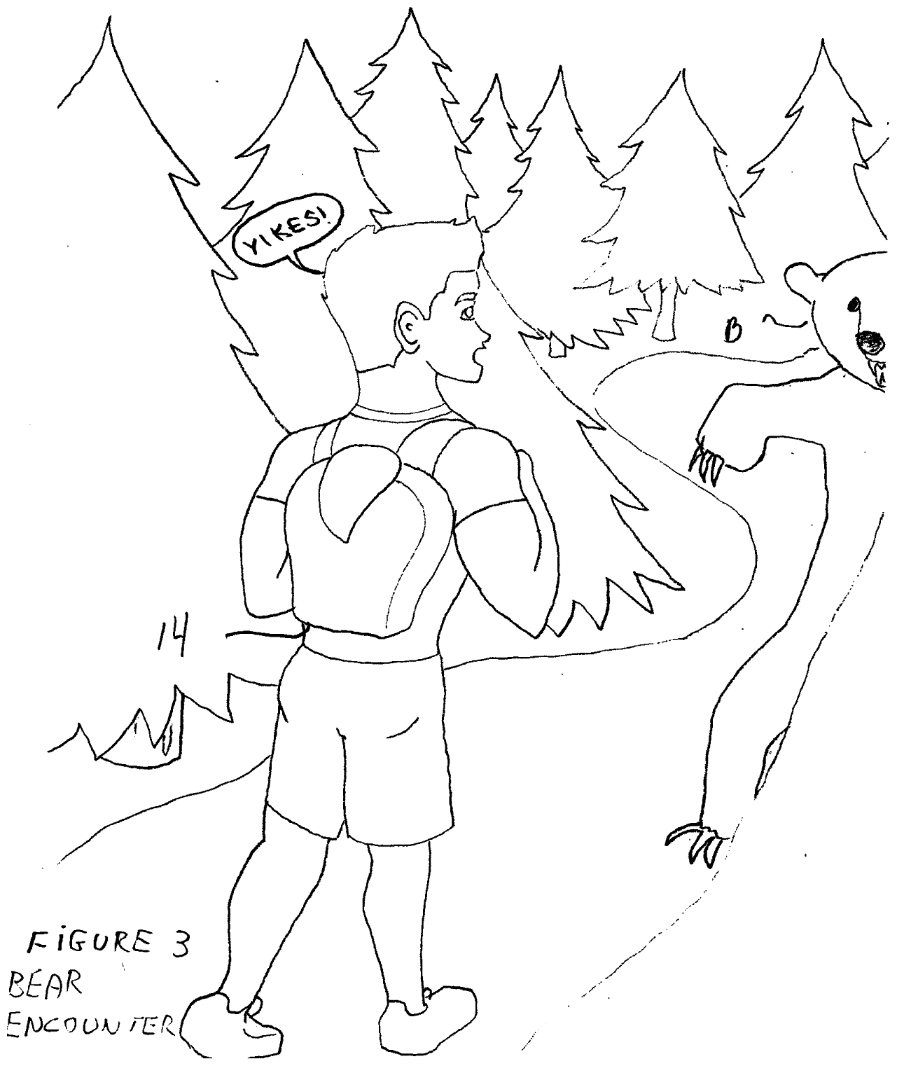

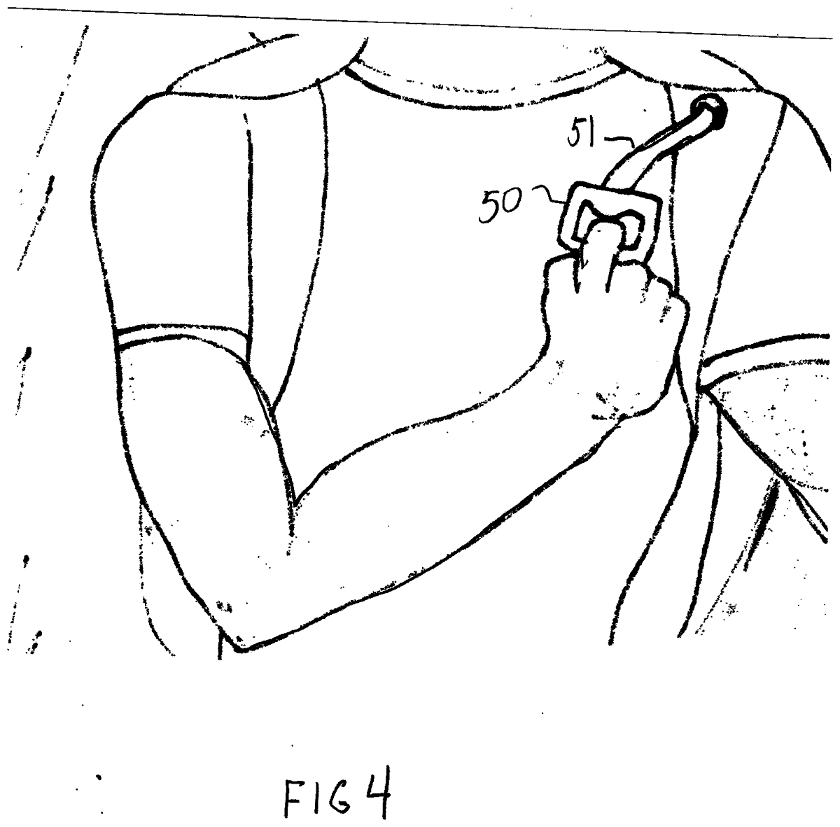

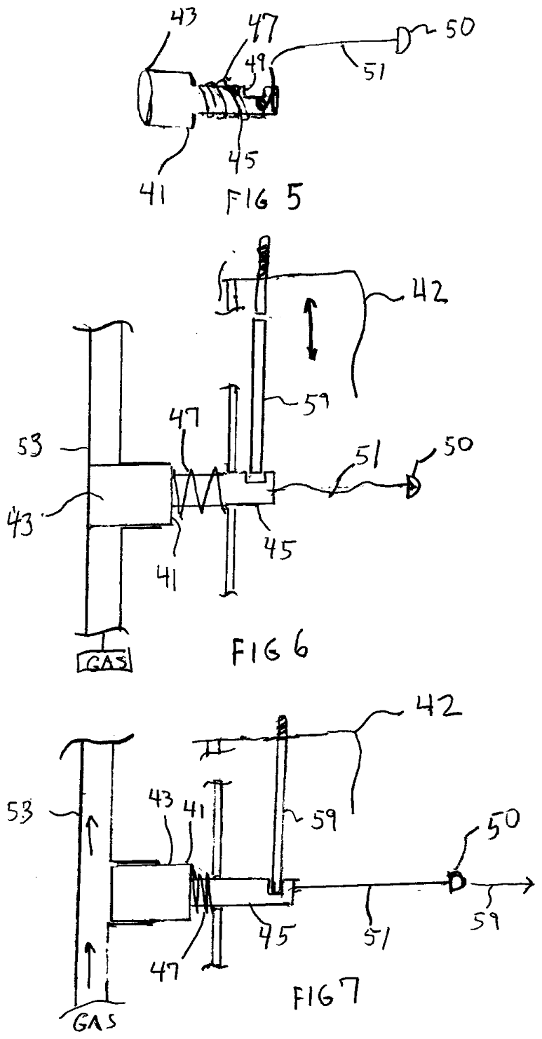

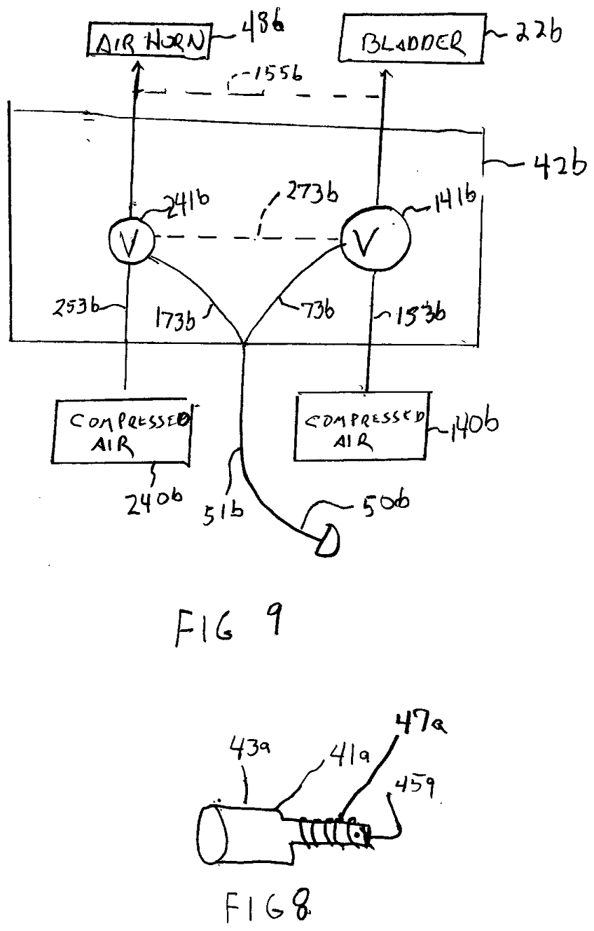

There is shown in FIG. 1 a preferred wild animal deterrent apparatus 10 in accordance with this invention. The apparatus is intended for use by a person P who has encountered a bear B or other wild animal in a forest, wilderness area or other remote location. Person P is depicted herein as a hiker and the wild animal is shown as a bear B. However it should be understood that apparatus 10 may be beneficially used by any person engaged in an activity such as hiking, backpacking, hunting, fishing, sightseeing, etc., which normally occurs in an outdoor setting such as a forest, park, wilderness, wildlife area or other analogous remote setting. It should be understood that the activity in which the person is engaged and the setting of that activity are not limitations of this invention. Moreover, apparatus 10 is likewise effective for deterring potential attacks by other large, threatening and/or dangerous wild animals including, but not limited to, cougars, mountain lions and wolves.

Apparatus 10, which is also shown alone in FIG. 2, features a collapsible display component 12 and a container 14 that accommodates various components for selectively opening and deploying display component 12 in the event person P encounters a bear B or other wild animal that appears to be aggressive or otherwise threatens to attack the person. In the preferred version disclosed herein, container 14 comprises a backpack. In other embodiments, alternative forms of containers, and particularly various types of wearing apparel such as jackets, coats or vests may be utilized. Nonetheless, a backpack is a convenient and effective way for enabling person P to carry apparatus 10 while hiking or otherwise moving through the forest, wilderness area or other remote outdoor location where wild animal encounters may occur. Backpack 14 is designed to fit snugly and comfortably on the upper back top of person P's shoulders behind the head (see also FIG. 3) and is secured in place by adjustable straps 16, FIG. 2. The top of backpack 14 has an open slit 18 that may be selectively held closed by a quick release fastener such as Velcro ™ or other hook and loop material.

As best shown in FIG. 1, display component 12 comprises a sheet-like display panel 19 that may be composed of canvas, polyester or various other natural or synthetic substances. Component 12 is illustrated in an opened and deployed condition in FIG. 1; but before the display component is deployed, it is stored, as shown in phantom in FIG. 2, in a collapsed or folded condition within an interior compartment 20 of backpack 14. Panel 19 of display component 12 includes an inflatable bladder 22 comprising an internal gas-transmitting passageway defined by separated layers or plies of panel 19. The bladder includes a peripheral bladder portion 24 featuring a lower bladder segment 26 formed along the lower edge of panel 19 and a communicably connected upper bladder segment 28 that extends peripherally about the remaining edge of panel 19 and communicably joins the two ends of lower bladder segment 26. Bladder 22 also includes a plurality of radially diverging bladder segments 30, each of which is communicably connected between lower edge peripheral bladder segment 26 and upper edge peripheral bladder segment 28. As a result, the individual segments of inflatable bladder 22 are communicably interconnected to one another.

The front or forwardly facing surface of panel 19 carries a graphic image 32 typically depicting the aggressive face of any known, typically large wild animal that is likely to be threatening or intimidating to the wild animal that person P may encounter and wish to scare away. The face of a large, angry and aggressive gorilla with an open mouth, large teeth and optionally attached synthetic hair and fur (not shown) is particularly preferred. Alternative graphic configurations of other wild animals and objects that may be frightening to an encountered bear or other wild animal common to the surrounding environment may alternatively be employed. Preferably, the graphic image should be larger, width by height, than the actual size of any bear or other potentially dangerous wild animal common to the area. Such size is more likely to frighten an animal that is facing and viewing the image. Preferably, the dimensions of the inflated display panel should be approximately at least 10 feet in height and 5 feet wide. This is described more fully below. Nonetheless, the shape and size of the display component 12, panel 19 and supported graphic image 32 may be varied in accordance with this invention.

As previously indicated, prior to deployment, display component 12 is folded or otherwise collapsed and held within compartment 20 of backpack 14. The interior compartment of the backpack also accommodates a number of additional components that are selectively activated and operated as needed to open and deploy the collapsed display component and supported graphic image. In particular, a pair (or other number) of compressed gas cartridges 40 are communicably connected to a valve comprising a valve block 42 that is, in turn, mounted within compartment 20 of backpack 14. The disclosed embodiment employs compressed air, but in other versions compressed CO2 or other gasses may be used. A pair of gas transmission tubes or hoses 44 are connected to respective outlets of valve block 42 and communicably joined to a gas distribution chamber 46, which, in turn, is communicably connected port by a standard air or gas inlet to inflatable bladder 22 and thereby bladder segments 26 and 30 of display component 12. A third gas outlet of valve block 42 is likewise communicably connected via tube 46 to an air horn 48 or other siren activated by compressed gas. As used herein, “siren” and “air horn should be deemed to include any loud audible device including without limitation horns, whistles, sirens and other devices effective in scaring distracting or otherwise deterring a potential wild animal attack.

A valve actuator handle 50 is mounted to one of the straps 16 of backpack 14 and operably connected by an actuator strap 51 to valve block 42. More particularly, valve block 42 includes spring biased closures not shown in FIG. 2 but see representative valve closure 41 in FIGS. 5-7. These valve closures are normally closed so that when deployment of display component 12 is not required, the compressed air cartridges 40 remain closed and air is not transmitted from cartridges 40 to air outlet tubes 44 and 46. Actuator handle 50 may be selectively operated by pulling the handle and attached strap to open the valve closures against the valve spring(s) and deliver compressed air from cartridges 40 to tubes 44, and from there to air distribution chamber 46 and bladder segments 26, 28 and 30 of display component 12. This operation is described more fully below. It should be understood that valve block 42 may comprise various types of valve structures known to persons skilled in the art. By the same token, the valve block includes an additional spring-loaded valve closure that operably interconnects the compressed gas cartridges 40 with air horn 48. That additional valve closure is typically opened to deliver compressed air to siren or horn 48 only when actuator handle 50 and strap 51 are pulled an additional amount beyond that required to open the valve to the air transmission tubes 44. Again, the valve block may be constructed in a manner that would be known to persons skilled in the art in order to deliver air or other compressed gas from the cartridges to the air horn/siren when the actuator handle 50 is pulled and extended a greater extent than that required to open the valve to the bladder passageways of the display component. The air horn is typically selected to provide for a low frequency roar similar to that produced by a large and aggressive wild animal. In either case, when the actuator handle 50 is released the spring loaded valve is returned to the normally closed condition, which discontinues delivery of gas to both the inflatable bladder and passageway of the display component and the air horn. Alternatively, when the valve is opened, the valve and/or filled bladder passageway may be locked, as described below, so that the passageway stays inflated and the display component remains deployed until the user engages an air release valve or valve reset on the valve block inside the backpack. This operation can be performed after the animal has departed and the threat of an attack has been removed.

FIG. 3 depicts person P wearing backpack 14 as he encounters an aggressive bear B. To scare away the bear and reduce the risk of serious or fatal injury to either person P or bear B, person P activates and deploys apparatus 10 by grabbing and pulling actuator handle 50 in the manner shown in FIG. 4. Strap 51 pulls the normally closed spring-loaded valve 42 open to communicably interconnect air cartridges 40 with air/gas transmission tubes 44. Compressed air is delivered through distribution chamber 46 to inflate bladder 22 of display component 12 and, more particularly, to fill the internal passageway of bladder segments 26, 28 and 30. This inflates the bladder and causes panel 19 and entire display component 12 to open and deploy rapidly through the Velcro ™ secured slit 18 at the upper end of the backpack. Display component 12 opens fully, as best shown in FIG. 1, such that panel 19 suddenly and prominently displays the large, aggressive and imposing wild animal facial image 32 to directly face the encountered bear B. Person P can continue pulling handle 50 and extending strap 51 further outwardly to open the closure of valve 42 connecting cartridges 40 to air horn 48. Compressed air is thereby delivered through valve 42 and conduit 46 to cause the air horn to produce a loud low frequency roar. The combination of the imposing and aggressive graphic display of a gorilla or other wild animal image, as well as the low frequency roar from air horn 48 will likely startle the encountered bear B, deter the bear from attacking and cause the bear to retreat and leave the area. As a result, both person P and bear B will avoid a confrontation that could cause serious injury or even death to the person and/or the bear.

FIG. 5 illustrates a representative spring biased valve closure 41 used in valve block 42. The valve closure is mounted for slidably moving back and forth in valve block 42 to open and close the valve respectively. Valve closure 41 includes a head 43 and attached stem 45. The stem is surrounded by a valve coil spring 47 that biases the closure into a closed state as described below. Stem 45 is operably connected to handle 50, FIG. 2, which may comprise a string, cord, strap, etc. An optional locking notch 49 engages a complementary locking pin 51, shown in FIGS. 6 and 7, to hold the valve closure in a locked open state when the display panel is deployed.

FIGS. 6 and 7 illustrate the representative closure 41 in closed and open states respectively. Gas transmission channel 53 is representative of any of the channels in valve block 42 that communicably interconnects a respective cartridge or other source of compressed gas 40 and a corresponding gas transmission tube 44, 46 (FIG. 1). As depicted In FIG. 6, normally, when valve actuator handle 50 is not pulled, valve spring 47 urges head 43 of valve closure 41 to engage and seat against valve channel 53 such that compressed air is blocked from transmission through the valve. As a result, the valve is closed, the bladder is not inflated, the display panel remains collapsed and/or (when the valve channel is connected to siren or horn 48) the horn is not sounded. When a potential dangerous wild animal encounter occurs and the handle 50 is pulled sufficiently, as shown in FIG. 7, head 43 of closure is withdrawn and unseated from valve channel 53. This transmits air or other compressed gas through channel 53 to inflate bladder 22, open the display panel and/or activate siren 48. In this state, spring-biased locking pin 51, which is retractably mounted on valve block 42, may be actuated and engaged with closure notch 49 such that valve closure 41 is locked in an open condition and compressed air continues to be transmitted through the valve block to inflate the bladder. The valve closure alternatively may be reset, as shown in FIG. 6, by retracting locking pin 59 to disengage the pin from the stem notch of the valve closure. Spring 47 urges head 43 back into and seated against channel 53. This closes the valve block channel 53 and discontinues the flow of compressed air therethrough. It should be noted that in alternative embodiments, the locking feature may be eliminated. In such cases the locking pin is not used and the valve closure 41a shown in FIG. 8 is employed. That closure again features a head 43a and attached stem 45a surrounded by a coil spring 47a. Otherwise, closure 41a is constructed and operates analogously to closure 41 as described above.

FIG. 9 is a simplified schematic representation of an alternative valve block 42b. A single bladder valve closure 141b and a single analogous air horn valve closure 241b are shown, each of which is constructed and operates analogously to the previously described valve closures. It should be understood that multiple bladder valve closures and multiple corresponding canisters or other sources of compressed air or other gas may be utilized within the scope of this invention. Moreover, either valve closure may feature the locking valve closure and pin shown in FIGS. 5-7 or the non-locking valve closure shown in FIG. 8. Alternative valve constructions and configurations for achieving selective delivery of compressed gas to the display panel bladder and air horn/siren and resultant operation of apparatus 10 will be understood by persons skilled in the art and may be employed within the scope of this invention. In particular, in FIG. 9, valve block 42b includes an air channel 153b communicably interconnecting compressed air source 140b to an air outlet tube or hose 44b, which, in turn, is communicably connected to inflatable bladder 22b. Block 42b also features a second air channel 253b communicably interconnecting compressed air source 240b to a hose 46b connected to air horn 48b. Alternatively, both the air horn and bladder may be connected to the single compressed air source 140b. An actuator handle 50b is operably attached to both bladder closure valve 141b and air horn closure valve 241b. Specifically handle 50b includes a strap, cord, line, string or other elongate element 51b that diverges into a first segment 73b attached to bladder valve closure 141b and a second segment 173b operably attached to air horn valve closure 141b. By pulling handle 50b valve closures 141b and 241b slide open as represented by valve closure 41 in FIGS. 4 and 5. This opens the valve block to inflate the bladder and sound the air horn. The valve closures can then be selectively locked, unlocked and reset as described above.

In alternative embodiments, handle 50b a may be serially connected to valve closures 141b and 241b by replacing second handle segment 173b with a handle segment 273b, shown in phantom, that interconnects bladder valve closure 141b with air horn valve closure 241b. In such cases, pulling the handle 50b an initial predetermined amount opens bladder valve closure 141b to inflate the bladder; and continuing to pull the handle an additional predetermined amount actuates and opens air horn valve closure 141b to sound the air horn.

Various alternative features may be employed within the scope of this invention. For example, various other numbers and configurations of bladders, passageways, bladder/passageway segments, air/gas transmission tubes and valves may be utilized. One or other multiple numbers of compressed air/gas cartridges may be employed. When multiple air/gas transmission tubes or hoses are used, an intermediate air/gas distribution chamber may be employed to distribute air or other compressed gas to one or more segments of the bladder and individual bladder passageways. In other embodiments, air may be delivered directly or by various types of pneumatic conduits from the valve(s)/valve block to the inflatable bladder. Alternative siren or air horn configurations may be used.

From the foregoing it may be seen that the apparatus of this invention relates to a wild animal deterrents device that employs reliable, fast-acting and effective pressurized air activation to deploy an imposing and aggressive graphic image and optional audible roar to diffuse a face to face confrontation between a person and a wild animal and avoid the likely dangerous consequences of a wild animal attack. While this detailed description has set forth particularly preferred embodiments of the apparatus of this invention, numerous modifications and variations of the structure of this invention, all within the scope of the invention, will readily occur to those skilled in the art. Accordingly, it is understood that this description is illustrative only of the principles of the invention and is not limitative thereof.

Although specific features of the invention are shown in some of the drawings and not others, this is for convenience only, as each feature may be combined with any and all of the other features in accordance with this invention.

1. A wild animal deterrent apparatus comprising:
a container having an interior compartment and opening into said compartment;
a collapsible display panel attached to and adapted for being collapsed into said interior compartment of said container, said display panel carrying a graphic image of an aggressive animal;
an inflatable bladder formed in said display panel;
a source of compressed gas disposed within said container and communicably connected to said air bladder;
a valve disposed within said container and operably interconnecting said source of compressed gas and said bladder; and
a valve actuator operably interconnected to said valve for selectively opening said valve to inflate said bladder such that said collapsed display panel opens and extends outwardly from said container and through said opening therein to reveal said graphic image.

2. The apparatus of claim 1 in which said source of compressed gas includes at least one compressed gas cartridge.

3. The apparatus of claim 1 in which said container includes a backpack for being carried by a person.

4. The apparatus of claim 1 in which at least one gas transmission tube communicably interconnects said valve and said bladder.

5. The apparatus of claim 4 further including a gas distribution chamber mounted within said compartment, which gas distribution chamber communicably interconnects each said gas transmission tube to said bladder.

6. The apparatus of claim 1 in which said bladder includes a peripheral bladder position that extends peripherally about said display component.

7. The apparatus of claim 6 in which said peripheral bladder portion includes a lower bladder segment extending along a lower edge of said display component and an upper bladder segment extending between respective ends of said lower bladder segment.

8. The apparatus of claim 7 in which said bladder also includes a plurality of radially diverging bladder segments, each of which communicably interconnects said lower bladder segment to a respective location of said upper bladder segment.

9. The apparatus of claim 1 in which a compressed gas activated siren is mounted in said container, said siren being connected to said valve such that such that said siren is deactivated and silent when said valve is closed, and said siren is activated when said valve is opened a predetermined amount by said valve actuator.

10. An apparatus for being worn by a person to deter an aggressive or threatening animal, the apparatus comprising:
a backpack adapted for being carried on the person's back, said backpack including an interior compartment and an opening into said interior compartment which opening is formed proximate an upper end of said backpack;
a collapsible display panel attached to and adapted for being collapsed into said interior compartment of said container, said display panel carrying a graphic image of an aggressive animal;
an inflatable bladder formed in said display panel;
a source of compressed gas disposed within said container and communicably connected to said bladder;
a valve disposed within said container and operably interconnecting said source of compressed gas and said bladder; and
a valve actuator operably interconnected to said valve for selectively opening said valve to inflate said bladder such that said collapsed display panel opens and extends outwardly and upwardly from said component, through said opening, and above the person to reveal said graphic image.

11. The apparatus of claim 10 in which said inflatable bladder includes a passageway formed between front and rear sides of said display panel.

12. The apparatus of claim 10 in which said source of compressed gas includes at least one compressed gas cartridge.

13. The apparatus of claim 10 in which at least one gas transmission tube communicably interconnects said valve and said bladder.

14. The apparatus of claim 4 further including a gas distribution chamber mounted within said compartment, which gas distribution chamber communicably interconnects each said air transmission tube to said air bladder.

15. The apparatus of claim 1 in which said bladder includes a peripheral bladder position that extends peripherally about said display component.

16. The apparatus of claim 15 in which said peripheral bladder portion includes a lower bladder segment extending along a lower edge of said display component and an upper bladder segment extending between respective ends of said lower bladder segment.

17. The apparatus of claim 16 in which said bladder also includes a plurality of radially diverging bladder segments, each of which communicably interconnects said lower bladder segment to a respective location of said upper bladder segment.

18. The apparatus of claim 10 in which a gas activated siren is mounted in said container, said siren being connected to said valve such that such that said siren is deactivated and silent when said valve is closed, and said siren is activated when said valve is opened a predetermined amount by said valve actuator.

19. The apparatus of claim 1 in which said inflatable bladder includes a passageway formed between front and rear sides of said display panel.
